(19) United States
(12) Patent Application Publication
(10) Pub. No.: US 2012/0211628 A1
(43) Pub. Date: Aug. 23, 2012

(54) EQUIPMENT MOVEMENT SYSTEM, PROCESS, AND ARTICLE

(75) Inventors: Scott FISHER, Las Vegas, NV (US); Alex MACDONALD, Las Vegas, NV (US)

(73) Assignee: FTSI, LLC, Las Vegas, NV (US)

(21) Appl. No.: 13/396,116

(22) Filed: Feb. 14, 2012

Related U.S. Application Data
(60) Provisional application No. 61/442,939, filed on Feb. 15, 2011.

(51) Int. Cl. F16M 13/02

(52) U.S. Cl. 248/329

(57) ABSTRACT

An equipment positioning system includes a reel apparatus, equipment and a control system. An equipment positioning apparatus is secured to cables forming at least three angled parallelograms extending between the reel apparatus and the equipment positioning apparatus. The cables are for positioning the equipment positioning apparatus and the equipment based upon signals from the control system. The cables are cooperatively extended or retracted by the reel apparatus thereby positioning one or more of the equipment positioning apparatus and the equipment. The cables forming the at least three angled parallelograms maintain the equipment positioning apparatus and the equipment in a stable orientation during operation of the equipment positioning system.

### FIELD OF THE INVENTION

The present disclosure is directed to systems, apparatuses, and processes for positioning equipment. More specifically, the present invention is directed to systems, apparatuses, and processes for positioning equipment by movement of one or more cables.

### BACKGROUND OF THE INVENTION

The demand for integrated multimedia experiences is constantly increasing. Spectators attending events or viewing events on televisions or computers increasingly desire additional views of the events to enhance the viewing experience. Likewise, individuals watching television shows, watching movies, and playing video games increasingly desire effects from vantage points not previously available.

In known systems, computer-generated graphics can utilize additional vantage points permitting desired effects. For example, an image can be digitally created and viewed without risk of rigging being in the image, with precise viewing vantage points, from any direction (both positional and angular), or combinations thereof. However, the computer-generated graphics suffer from several drawbacks. For example, producing computer-generated graphics requires substantial time, can be expensive, can be distinguished from real images, and is not compatible with live events.

Live camera feeds have not traditionally provided vantage points desirable for enhanced viewing of events. Booms and levers for positioning cameras at various vantage points are unable to be positioned over a large range of positions or angled from certain vantage points. Even at smaller events, booms and levers suffer from the drawback that they can impede the view of a live audience, block lighting rigs, or otherwise interfere with the event.

In a known system generally used at large outdoor events such as for football broadcasts, a reel having a motor drive and at least three cables is attached to a spur having a mechanism capable of panning and tilting a video camera secured to the spur. In this known system, a first user modifies the position of the mechanism in the spur and a second user modifies the panning and tilting of the camera while maintaining the spur in controllable isolation from angular movement. This known system suffers from several drawbacks. For example, the spur can be relatively heavy, creating a safety hazard. In addition, for panning and tilting of the camera, the mechanism in the spur must include rotatable portions that may be exposed to cold temperatures, rain, snow, or other environmental hazards and degrade. Furthermore, use of this system at small events can be undesirable because the rotation of the spur for panning and tilting generates noise that may be picked up by microphones at the event.

A system, apparatus, and process for positioning equipment that does not suffer from the above drawbacks is desired.

### BRIEF DESCRIPTION OF THE INVENTION

According to an embodiment, an equipment positioning system includes a reel apparatus, equipment and a control system. An equipment positioning apparatus is secured to cables forming at least three angled parallelograms extending between the reel apparatus and the equipment positioning apparatus. The cables are for positioning the equipment positioning apparatus and the equipment based upon signals from the control system. The cables are cooperatively extended or retracted by the reel apparatus thereby positioning one or more of the equipment positioning apparatus and the equipment. The cables forming the at least three angled parallelograms maintain the equipment positioning apparatus and the equipment in a stable orientation during operation of the equipment positioning system.

According to another embodiment, an equipment positioning system includes a reel apparatus, equipment and a control system. An equipment positioning apparatus is secured to cables forming at least three angled parallelograms extending between the reel apparatus and the equipment positioning apparatus. The cables are for positioning the equipment positioning apparatus and the equipment based upon signals from the control system. The cables are cooperatively extended or retracted by the reel apparatus thereby positioning one or more of the equipment positioning apparatus and the equipment. The cables forming the at least three angled parallelograms maintain the equipment positioning apparatus and the equipment in a stable orientation during operation of the equipment positioning system. In this embodiment, the equipment positioning system includes an upper cable engagement feature and a lower engagement feature.

According to another embodiment, an equipment positioning system includes a reel apparatus, equipment and a control system. An equipment positioning apparatus is secured to cables forming at least three angled parallelograms extending between the reel apparatus and the equipment positioning apparatus. The cables are for positioning the equipment positioning apparatus and the equipment based upon signals from the control system. The cables are cooperatively extended or retracted by the reel apparatus thereby positioning one or more of the equipment positioning apparatus and the equipment. The cables forming the at least three angled parallelograms maintain the equipment positioning apparatus and the equipment in a stable orientation during operation of the equipment positioning system. In this embodiment, the reel apparatus includes a first drive and a second drive.

According to another embodiment, an equipment positioning system includes a reel apparatus, equipment and a control system. An equipment positioning apparatus is secured to cables forming at least three angled parallelograms extending between the reel apparatus and the equipment positioning apparatus. The cables are for positioning the equipment positioning apparatus and the equipment based upon signals from the control system. The cables are cooperatively extended or retracted by the reel apparatus thereby positioning one or more of the equipment positioning apparatus and the equipment. The cables forming the at least three angled parallelograms maintain the equipment positioning apparatus and the equipment in a stable orientation during operation of the equipment positioning system. In this embodiment, the reel apparatus includes a variable height mechanism operably connected to the one or more of the cables.

According to another embodiment, an equipment positioning system includes a reel apparatus, equipment and a control system. An equipment positioning apparatus is secured to cables forming at least three angled parallelograms extending between the reel apparatus and the equipment positioning apparatus. The cables are for positioning the equipment positioning apparatus and the equipment based upon signals from the control system. The cables are cooperatively extended or retracted by the reel apparatus thereby positioning one or more of the equipment positioning apparatus and the equipment. The cables forming the at least three angled parallelograms maintain the equipment positioning apparatus and the equipment in a stable orientation during operation of the equipment positioning system. In this embodiment, the control system includes a controller for selectively positioning the equipment positioning apparatus by extending or retracting the cables. The controller is configured to receive data selected from the group consisting of drive power data for a first drive and second drive configured to extend and retract one or more of the cables, variable height mechanism position data for a variable height mechanism in a reel apparatus operably connected to one or more of the cables, equipment positioning apparatus data for a first portion and a second portion of the equipment positioning apparatus, and combinations thereof.

According to another embodiment, an equipment positioning apparatus includes a predetermined number of cable engagement features arranged to be secured to cables to form at least three angled parallelograms extending between a reel apparatus and an equipment positioning apparatus. The cables are for positioning the equipment positioning apparatus and the equipment based upon signals from a control system. The cables are cooperatively extended or retracted by the reel apparatus thereby positioning one or more of the equipment positioning apparatus and the equipment. The cables forming the at least three angled parallelograms maintain the equipment positioning apparatus and the equipment in a stable orientation during operation of the equipment positioning apparatus.

According to another embodiment, an equipment positioning apparatus includes a predetermined number of cable engagement features arranged to be secured to cables to form at least three angled parallelograms extending between a reel apparatus and an equipment positioning apparatus. The cables are for positioning the equipment positioning apparatus and the equipment based upon signals from a control system. The cables are cooperatively extended or retracted by the reel apparatus thereby positioning one or more of the equipment positioning apparatus and the equipment. The cables forming the at least three angled parallelograms maintain the equipment positioning apparatus and the equipment in a stable orientation during operation of the equipment positioning apparatus. In this emobodiment, the cable engagement features includes an upper cable engagement feature and a lower engagement feature.

According to another embodiment, an equipment positioning apparatus includes a predetermined number of cable engagement features arranged to be secured to cables to form at least three angled parallelograms extending between a reel apparatus and an equipment positioning apparatus. The cables are for positioning the equipment positioning apparatus and the equipment based upon signals from a control system. The cables are cooperatively extended or retracted by the reel apparatus thereby positioning one or more of the equipment positioning apparatus and the equipment. The cables forming the at least three angled parallelograms maintain the equipment positioning apparatus and the equipment in a stable orientation during operation of the equipment positioning apparatus. In this emobodiment, the includes a reel apparatus for selectively extending and retracting one or more of the cables thereby positioning equipment operably connected to the one or more cables, the reel apparatus includes a first drive and a second drive.

According to another embodiment, an equipment positioning apparatus includes a predetermined number of cable engagement features arranged to be secured to cables to form at least three angled parallelograms extending between a reel apparatus and an equipment positioning apparatus. The cables are for positioning the equipment positioning apparatus and the equipment based upon signals from a control system. The cables are cooperatively extended or retracted by the reel apparatus thereby positioning one or more of the equipment positioning apparatus and the equipment. The cables forming the at least three angled parallelograms maintain the equipment positioning apparatus and the equipment in a stable orientation during operation of the equipment positioning apparatus. In this emobodiment, the reel apparatus includes a variable height mechanism operably connected to the one or more of the cables.

According to another embodiment, a method for positioning equipment includes providing an equipment positioning apparatus having engagement features. The method further includes selectively positioning the equipment positioning apparatus by selective extension or retraction of cables secured to the equipment positioning apparatus forming at least three angled parallelograms. The cables forming the at least three angled parallelograms maintain the equipment positioning apparatus and the equipment in a stable orientation during operation of the equipment positioning apparatus.

According to another embodiment, a method for positioning equipment includes providing an equipment positioning apparatus having engagement features. The method further includes selectively positioning the equipment positioning apparatus by selective extension or retraction of cables secured to the equipment positioning apparatus forming at least three angled parallelograms. The cables forming the at least three angled parallelograms maintain the equipment positioning apparatus and the equipment in a stable orientation during operation of the equipment positioning apparatus. In this embodiment, the equipment positioning apparatus includes an upper cable engagement feature and a lower engagement feature.

According to another embodiment, a method for positioning equipment includes providing an equipment positioning apparatus having engagement features. The method further includes selectively positioning the equipment positioning apparatus by selective extension or retraction of cables secured to the equipment positioning apparatus forming at least three angled parallelograms. The cables forming the at least three angled parallelograms maintain the equipment positioning apparatus and the equipment in a stable orientation during operation of the equipment positioning apparatus. In this embodiment, selectively positioning the equipment positioning apparatus includes selectively positioning an equipment positioning apparatus by selective extension or retraction of at least one of the cables operably connected to a reel apparatus, wherein the reel apparatus includes a first drive and a second drive.

According to another embodiment, a method for positioning equipment includes providing an equipment positioning apparatus having engagement features. The method further includes selectively positioning the equipment positioning apparatus by selective extension or retraction of cables secured to the equipment positioning apparatus forming at least three angled parallelograms. The cables forming the at least three angled parallelograms maintain the equipment positioning apparatus and the equipment in a stable orientation during operation of the equipment positioning apparatus. In this embodiment, the reel apparatus includes a variable height mechanism operably connected to at least one of the cables.

According to another embodiment, a method for positioning equipment includes providing an equipment positioning apparatus having engagement features. The method further includes selectively positioning the equipment positioning apparatus by selective extension or retraction of cables secured to the equipment positioning apparatus forming at least three angled parallelograms. The cables forming the at least three angled parallelograms maintain the equipment positioning apparatus and the equipment in a stable orientation during operation of the equipment positioning apparatus. In this embodiment, selectively positioning the equipment positioning apparatus includes selectively positioning the equipment positioning apparatus by extending or retracting cables in response to data gathered, the data selected from the group consisting of drive power data for a first drive and second drive configured to extend and retract one or more of the cables, variable height mechanism position data for a variable height mechanism in a reel apparatus operably connected to one or more of the cables, equipment positioning apparatus data for a first portion and a second portion of the equipment positioning apparatus, and combinations thereof.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows an exemplary equipment positioning system according to an embodiment of the disclosure.

FIG. 2 shows an exemplary equipment positioning system according to an embodiment of the disclosure.

FIG. 3 shows an exemplary equipment positioning system in an elevated position according to an embodiment of the disclosure.

FIG. 4 shows an exemplary equipment positioning system in a lowered position according to an embodiment of the disclosure.

FIG. 5 shows an exemplary reel apparatus according to an embodiment of the disclosure.

FIG. 6 shows an exemplary reel apparatus according to an embodiment of the disclosure.

FIG. 7 shows an exemplary equipment positioning apparatus according to an embodiment of the disclosure.

FIG. 8 shows an exemplary equipment positioning apparatus according to an embodiment of the disclosure.

FIG. 9 shows an exemplary equipment positioning apparatus according to an embodiment of the disclosure.

FIG. 10 shows an exemplary equipment positioning apparatus according to an embodiment of the disclosure.

FIG. 11 shows an exemplary equipment positioning apparatus with a camera in an exemplary position according to an embodiment of the disclosure.

FIG. 12 shows an exemplary equipment positioning apparatus with a camera in an exemplary position according to an embodiment of the disclosure.

FIG. 13 shows an exemplary equipment positioning apparatus with a camera in an exemplary position according to an embodiment of the disclosure.

FIG. 14 shows an exemplary equipment positioning system according to an embodiment of the disclosure.

Wherever possible, the same reference numbers will be used throughout the drawings to represent the same parts.

### DETAILED DESCRIPTION OF THE INVENTION

Provided is a system, apparatus, and process for positioning equipment (for example, a camera) by movement of one or more cables. Embodiments of the present disclosure permit additional views for events allowing enhanced viewing experience and/or additional desired effects (such as viewing from a greater range of vantage points), permit use with live events, reduce views of live audiences being impeded, reduce unintentional effects on lighting and/or sound, permit enhanced panning and tilting of the equipment in conjunction with a panning/tilting-enabled spur capable of panning and tilting, permit additional stability control, reduce the weight by reducing or eliminating features that would otherwise be secured to the equipment, enhance weather-resistance of the system, and combinations thereof.

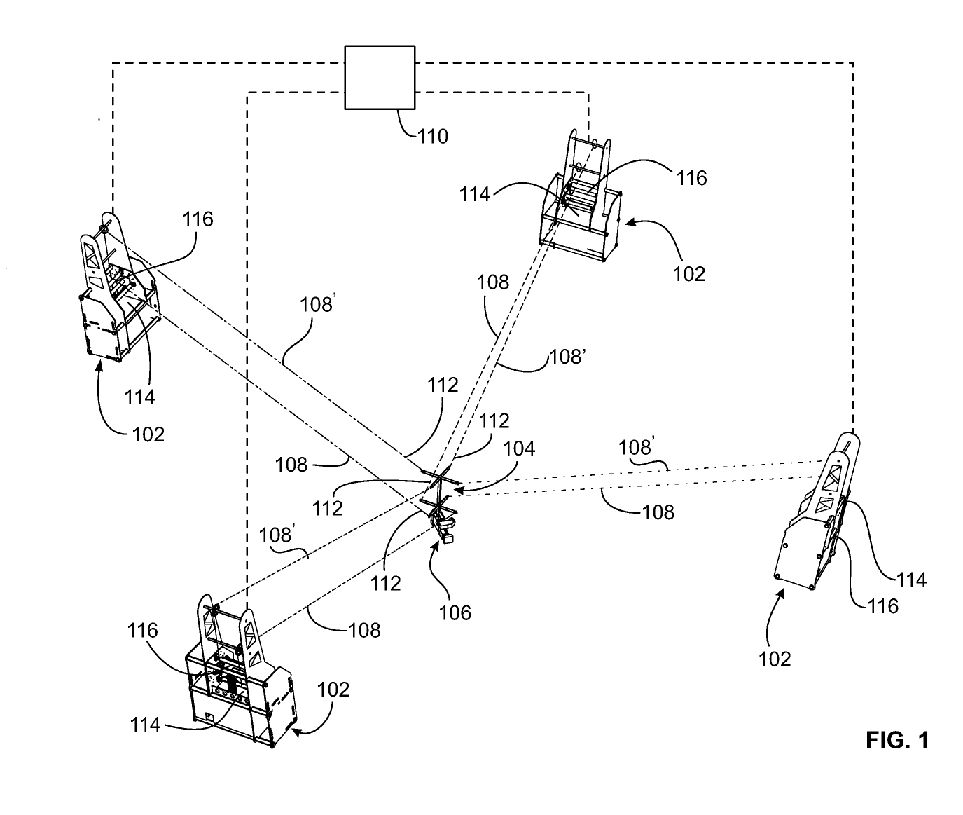

Referring to FIG. 1, in one embodiment, an equipment positioning system 100 includes a reel apparatus 102, an equipment positioning apparatus 104, and cables 108 for positioning equipment 106 based upon one or more signals from a control system 110 including one or more controllers. The cables 108 are extended or retracted by the reel apparatus 102 thereby positioning one or more of the equipment positioning apparatus 104 and the equipment 106. Suitable equipment 106 includes, but is not limited to, a camera, a speaker, a lighting element, a lighting system, a disco ball, mirror, a chandelier, suspended platform, a promotional display, a scoreboard, and combinations thereof. For example, in one embodiment, the equipment 106 is a camera system. The camera system includes, for example, a camera, one or more batteries, one or more transmitters (wireless and/or wired) one or more receivers (wireless and/or wired), support structures, positioning or orienting systems, tilt control systems, panning control systems, global positioning systems, other suitable features, and combinations thereof.

In one embodiment, the equipment 106 is within a predetermined range of weight. Exemplary weight ranges include about 2 pounds, less than 2 pounds, between about 1 pound and 3 pounds, about 5 pounds, less than 5 pounds, between about 2 and 7 pounds, about 25 pounds, less than 25 pounds, between about 20 pounds and 30 pounds, about 50 pounds, less than 50 pounds, between about 20 and 70 pounds, about 75 pounds, less than 75 pounds, between about 50 pounds and 100 pounds, about 75 pounds, less than 100 pounds, between about 75 and 125 pounds, about 100 pounds, greater than 100 pounds, or any other suitable weight or weight range.

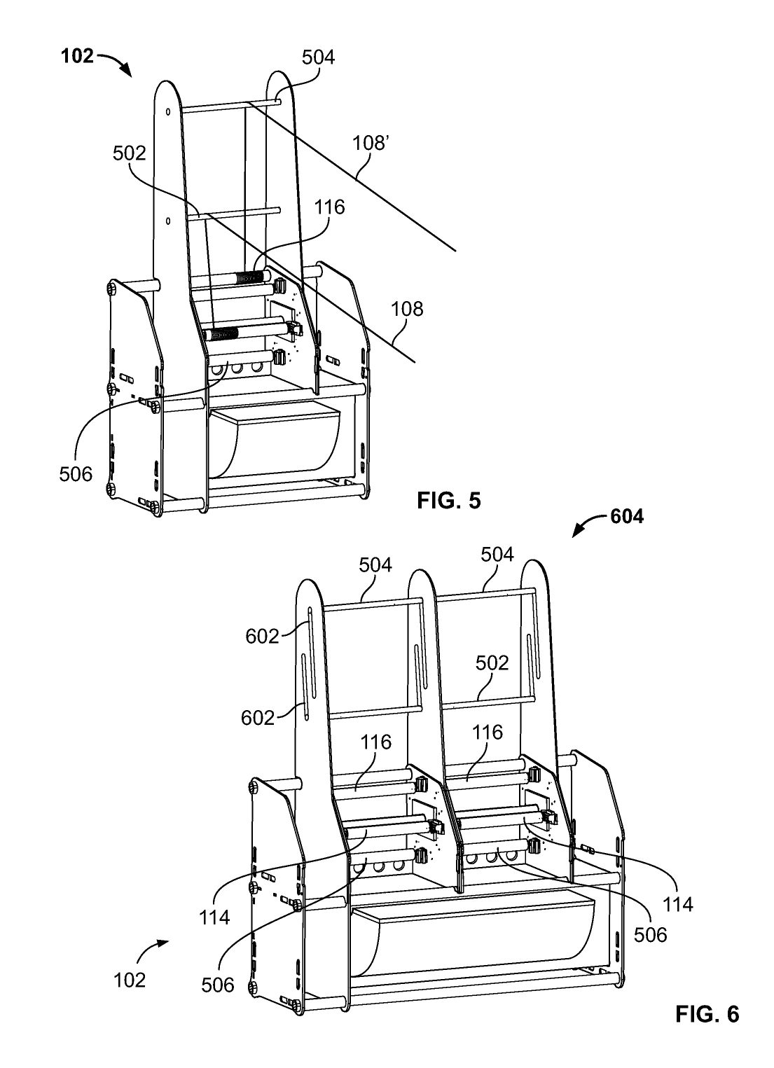

As shown in some of the figures, a distinction is identified between upper cables 108′ and lower cables 108, such as shown in FIG. 5 with respective upper reel 504 and lower reel 502. However, the cables are generally referred to as cables 108, when the term applies to one or more of either upper cables and lower cables or collectively to all cables.

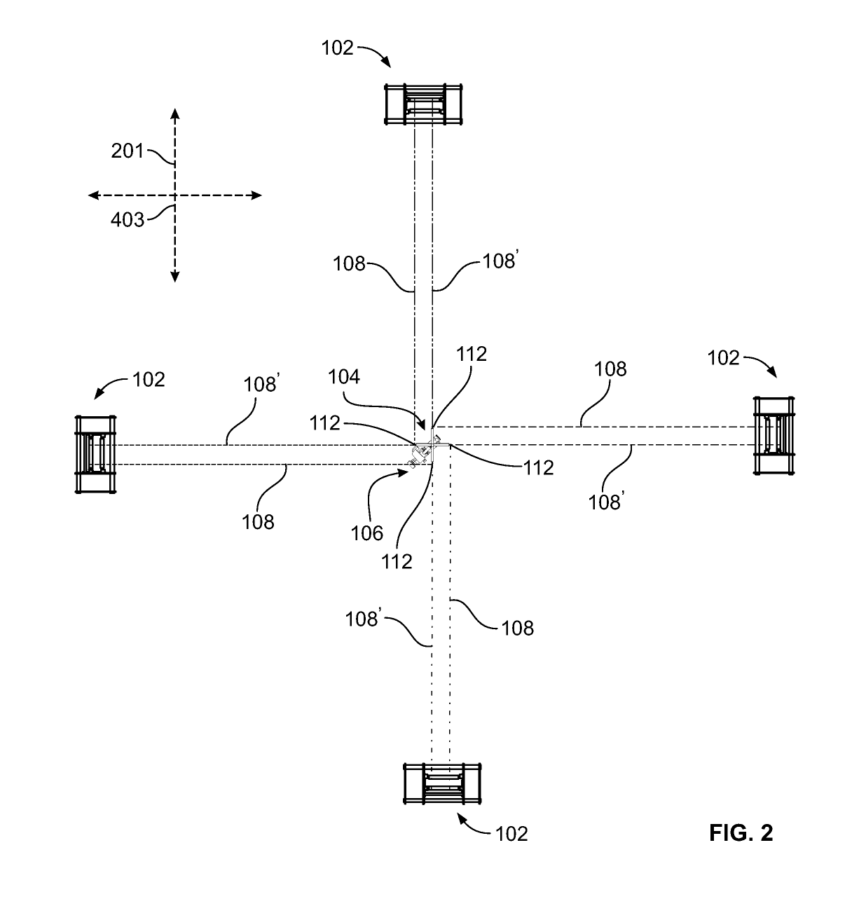

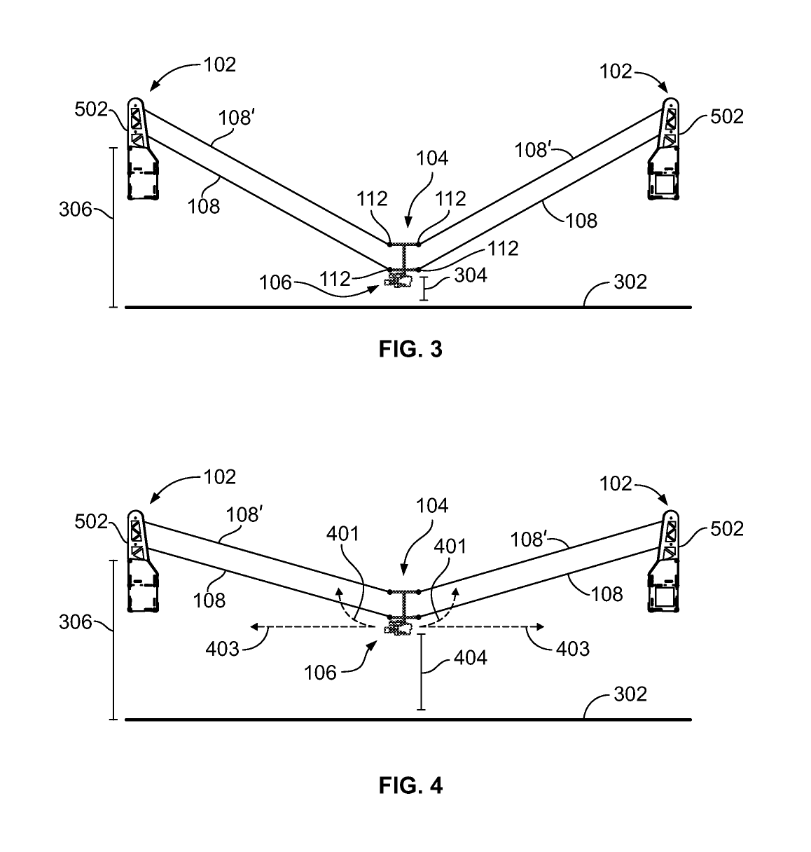

Cable engagement features 112 operably connect the cables 108 between the reel apparatus 102 and the equipment apparatus 104. The cables 108 are connected to the cable engagement features 112 by any suitable mechanism. Suitable mechanisms include, but are not limited to, loop and closed-hook mechanisms, connectors guided by magnets for alignment, bolts or other fasteners, and cable splices. Any suitable number of engagement features 112 are included. In one embodiment, as best shown in FIGS. 2-4, the equipment positioning apparatus 104 includes a predetermined number of cable engagement features 112 permitting coordinated movement over a predetermined region, including movement along a longitudinal axis 403 and/or a latitudinal axis 201, as well vertical movement as shown in FIGS. 3 and 4 reflecting the differences in magnitude of between lowered position 304 (FIG. 3) and raised position 404 (FIG. 4). Movement of the equipment positioning apparatus 104 over the predetermined region is maintained in a stable orientation. As used herein, the term “stable orientation” refers to a substantial resistance to angular movement, such as a substantial resistance to angular movement 401 as shown in FIG. 4, despite being maintained in a position anywhere within a predetermined three dimensional space or region, or moved in any combination of directions within the predetermined three dimensional space or region. Stated another way, the stable orientation provides torsional resistance to resist inertia of the equipment positioning apparatus 104 and equipment 106, such as required to achieve a high speed rotational movement of a camera, also referred to as “panning”

As shown in FIGS. 1-2, in one embodiment, eight cable engagement features 112 are included. In one embodiment, more cable engagement features 112 are included than cables 108 providing additional adjustability. In another embodiment, multiple cables 108 engage one cable engagement feature 112 permitting reduced weight of the equipment positioning apparatus 104. In the embodiment shown in FIGS. 1-2, the cable engagement features 112 are positioned at a predetermined distance from a center axis of the equipment positioning apparatus 104. In this embodiment, the equipment positioning apparatus 104 is maintained in a stable orientation while maintaining the equipment 106 in a fixed position or moving the equipment 106.

As shown in FIGS. 1-4, the cables 108 engaging the cable engagement features 112 and supporting the equipment positioning apparatus 104 and the equipment 106 form four angled parallelograms to maintain the equipment positioning apparatus 104 and the equipment 108 in a stable orientation. As shown in FIGS. 1-2, and discussed in further detail below, adjustable offsets of reel apparatus 102 corresponding to equipment positioning apparatus 104 can be employed to form angled parallelograms. In one embodiment, the connections of the cables forming the angled parallelograms with the cable engagement features 112 of the equipment positioning apparatus 104 form a helical arrangement, contributing to provide a stable orientation of the equipment positioning apparatus 104 and the equipment 108. In a further embodiment, three angled parallelograms could be used to achieve a stable orientation of the equipment positioning apparatus 104 and the equipment 108. In yet a further embodiment, more than four angled parallelograms could be used to achieve a stable orientation of the equipment positioning apparatus 104 and the equipment 108.

The equipment positioning apparatus 104 includes an upper cable engagement feature 112 and a lower engagement feature 112. As used herein, the terms “upper” and “lower” relate to elevational descriptions independent of position respective to longitude and latitude based upon a resting mode of the system 100. It will be appreciated that operation of the system 100 may result in portions identified as upper portions being below lower portions and lower portions being above upper portions while in an operational mode of the system 100.

The cables 108 are any suitable cable capable of supporting the weight of the equipment positioning apparatus 104 and the equipment 106 as well as being capable of being extended and retracted by the reel apparatus 102. In one embodiment, one or more of the cables 108 are configured for transmitting signals (for example, through electrical signals) from the equipment positioning apparatus 104 to the reel apparatus 102. For example, in one embodiment, the cable(s) 108 include fiber-optic interiors with a durable exterior (for example, a flexible polymeric coating or a flexible metal coating). In one embodiment, one or more of the cables 108 includes an woven aramid fiber (for example, a polyamide fiber). In one embodiment, one or more of the cables 108 are steel cables and/or are of a gauge capable of supporting up to about 600 pounds on a single cable. In another embodiment, one or more of the cables 108 are braided Kevlar-jacketed. In one embodiment, the cables 108 within the system 100 include different materials permitting the cables to include various features. For example, in one embodiment, one of the cables 108 is configured for transmitting a signal but another one of the cables 108 is a steel cable. In this embodiment, costs of including multiple cables 108 capable of transmitting a signal can be avoided and additional strength and/or stability can be achieved. In other embodiments, one or more of the cables 108 is synthetic, non-synthetic, metal, polymeric, a high-strength material, a signal bearing wire, a power bearing wire, a support cable, other suitable materials or features, or combinations thereof.

Referring to FIGS. 3-4, cables 108 are cooperatively extended and retracted to position the equipment 106 in a lowered position (see FIG. 3) or a raised position (see FIG. 4). By selective and controlled extension and retraction of the cables 108, the equipment 106 is capable of being positioned at any suitable height below a lower cable reel height 306 (i.e., the height of the cable 108 extending from a lower reel 502 of the reel apparatus 102) from a substantially planar reference 302 (for example, any suitable surface, a dance floor, a football field, an ice rink, a basketball court, water such as in a swimming pool, or a crowd). The equipment 106 is capable of being positioned at a lowered height 304 from the reference 302 as shown in FIG. 3 and a raised height 404 from the reference 302 as shown in FIG. 4. Full retraction of the cables 108 positions the cables 108 substantially parallel to the reference 302 with the equipment positioning apparatus 104 forming a line with the cables 108 and the equipment 106 suspended below the cables 108.

Referring to FIGS. 5-6, in one embodiment, the reel apparatus 102 for selectively extending and retracting one or more cables 108 thereby positioning the equipment 106 is operably connected to the one or more cables 108. Referring to FIG. 5, in one embodiment, the reel apparatus includes the lower reel 502 for the lower cable 108 and an upper reel 504 for the upper cable 108′. The lower reel 502 and/or the upper reel 504 is any suitable slidable or rotatable mechanism. For example, suitable reel(s) include pulleys, lubricated members, grooved members, rotatable members, or combinations thereof. The lower cable 108 extends around the lower reel 502 and is extended and retracted by a lower cable drive 114. The upper cable 108′ extends around the upper reel 504 and is extended and retracted by an upper cable drive 116. In one embodiment, as shown in FIGS. 1, 2 and 14, lateral spacing of cables along the upper and lower reels of reel apparatus 102 can be selectively controlled, such as with pulleys. The lower cable drive 114 is positioned below and closer to the equipment 106 than the upper cable drive 116 to avoid the upper cable 108′ and the lower cable 108 making contact in the reel apparatus 102. The upper cable 108′ is slightly offset from the lower cable 108 further preventing contact between the upper cable 108′ and the lower cable 108. In one embodiment, as shown in FIGS. 1, 2 and 14, the upper cable 108′ and lower cable 108 from the reel apparatus 102 engage the equipment positioning apparatus 104 on different rotational portions (for example, about ninety degrees apart) further preventing contact between the upper cable 108′ and the lower cable 108, and combined with the lateral offset of the cables at reel apparatus 102, form four angled parallelograms as previously discussed above, providing a stable orientation of the equipment positioning apparatus 104 and equipment 106.

Referring again to FIG. 5, in one embodiment, a joint reel 506 is included. In one embodiment, the joint reel 506 is a reel as described above. In this embodiment, the joint reel 506 permits the upper cable 108′ and the lower cable 108 to operate as one cable extending around the joint reel 506. In another embodiment, the joint reel 506 is positioned below the lower reel 502 and the lower cable drive 114. In this embodiment, the joint reel 506 is a cable drive and extends and retracts a third cable (not shown) positionable below the lower cable 108. In a another embodiment, the joint reel 506 is a cable drive and is connected to one or more of the upper cable drive 116 and the lower cable drive 114. In this embodiment, the joint reel 506 operates as a back-up drive providing additional power to one or more of the upper cable drive 16 and the lower cable drive 114.

The lower cable drive 114, the upper cable drive 116, and/or the joint reel 506 (in the embodiment where the joint reel 506 is a cable drive) is any suitable drive. In one embodiment, one or more of the lower cable drive 114, the upper cable drive 116, and/or the joint reel 506 is configured to operate at a predetermined power (for example, about 4.5 hp (3.4 kW)). In one embodiment, drive parameters (for example, torque, velocity, acceleration, power, and/or smoothness of operation) are selectively adjusted.

Referring to FIG. 6, in one embodiment, the reel apparatus 102 includes a variable height mechanism 602 operably connected to the one or more of the cables 108 and/or a second set 604 of reels and drives. In this embodiment, the variable height mechanism 602 permits the lower reel height 306 (see FIGS. 3-4) and/or an upper reel height 308 (see FIGS. 3-4) to be selectively adjusted. Such selective adjustment permits additional stability in operation of the equipment 106. In embodiments with the second set 604 of reels and drives, the reel apparatus 102 is capable of extending between one and six cables 108. In other embodiments, more than three sets of reels and drives and/or more than six cables 108 are operated by the reel apparatus 102. In another embodiment, the reel apparatus 102 is laterally positionable along a track (for instance a rail track) permitting further selective adjustability. In addition to the additional selective adjustment, the selective adjustability of the reel apparatus 102 permits tension to be applied to the 180 cable in response to a direction of wind.

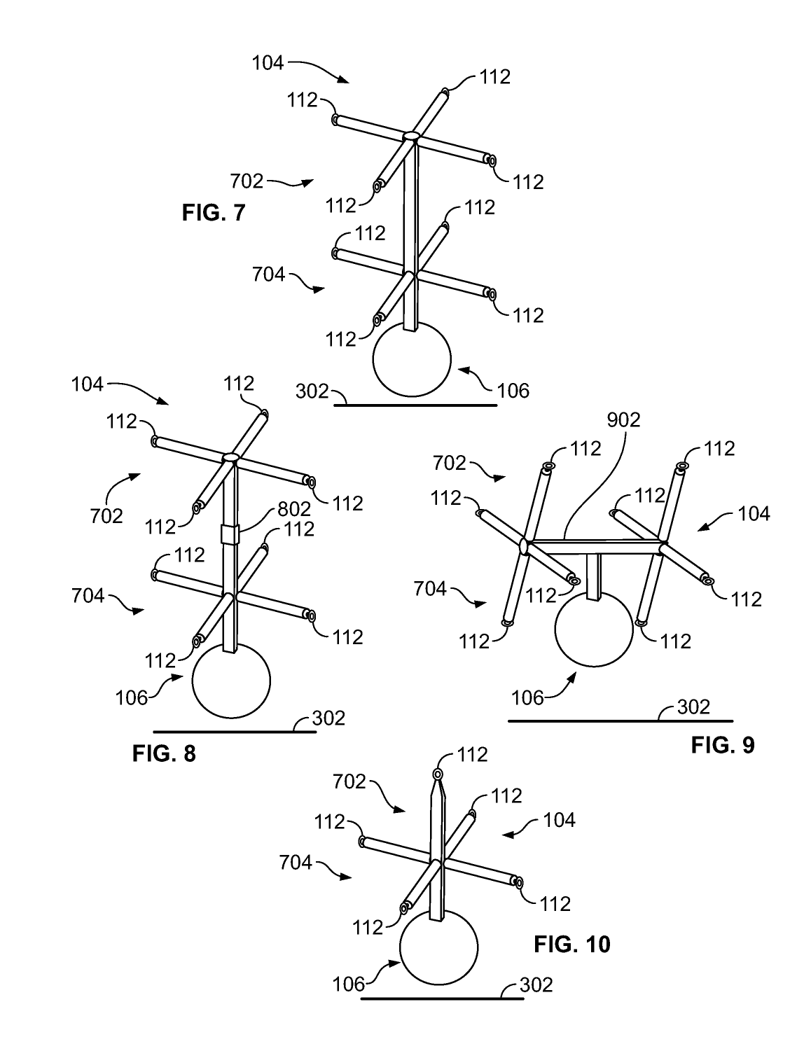

Referring to FIGS. 7-10, the equipment positioning apparatus 104 selectively positions the equipment 106 by selective adjustment of the reel apparatus 102 (for example, by selective extension or retraction of some or all of the cables 108, by selective adjustment of drive parameters, by selective adjustment of the lower reel height 306 and/or the upper reel height 308, by selective adjustment of the lateral position of the upper and lower reels 502, 504 with respect to each other and/or of the reel apparatus 102, and combinations thereof). Referring to FIG. 7, in one embodiment, the equipment positioning apparatus 104 includes an upper portion 702 and a lower portion 704 each including engagement features 112. In one embodiment, the upper portion 702 is at a distance from the lower portion 704 substantially equal to the distance between the upper reels 504 and the lower reels 502 of the reel apparatuses 102.

Referring to FIG. 8, in one embodiment, the upper portion 702 and the lower portion 704 are rotatable about a coupling 802. In this embodiment, the coupling 802 permits independent rotation of the upper portion 702 and the lower portion 704 of the equipment positioning apparatus 104. In a further embodiment, the coupling 802 is selectively rigid such that rotation between the upper portion 702 and the lower portion 704 can be permitted and prevented in response to a signal from the control system 110.

In one embodiment, the equipment positioning apparatus 104 includes at least one more engagement features 112 than reel apparatus 102. For example, in an embodiment having four reel apparatuses 102, as shown in FIG. 10, the equipment positioning apparatus 104 includes five engagement features 112. The engagement features 112 correspond to cables 108 from predetermined reels of the reel apparatus 102. The engagement features 112 are arranged in any suitable arrangement on the equipment positioning apparatus 104. Referring to FIG. 7, in one embodiment, four engagement features 112 are located on the upper portion 702, four engagement features 112 are positioned on the lower portion 704 of the equipment positioning apparatus 104, and the equipment 106 is suspended below the lower portion 704. In one embodiment, the lower engagement features 112 rest at substantially the same height as each other and the upper engagement features 112 rest at substantially the same height as each other when the system 100 is in resting mode. In one embodiment, the four upper engagement features 112 engage four upper cables 108′ corresponding to four upper reels 504. Likewise, in this embodiment, the four lower engagement features 112 engage four lower cables 108 corresponding to four lower reels 502.

Referring to FIG. 9, in one embodiment of the equipment positioning apparatus 104, four engagement features 112 are located on the upper portion 702, four engagement features 112 are positioned on the lower portion 704, and the equipment 106 is suspended from a lateral member 902 below the upper portion 702 and above the lower portion 704. In one embodiment, the lower engagement features 112 rest at substantially the same height as each other and the upper engagement features 112 rest at substantially the same height as each other when the system 100 is in resting mode. In one embodiment, the four upper engagement features 112 engage four upper cables 108′ corresponding to four upper reels 504. Likewise, in this embodiment, the four lower engagement features 112 engage four lower cables 108 corresponding to four lower reels 502.

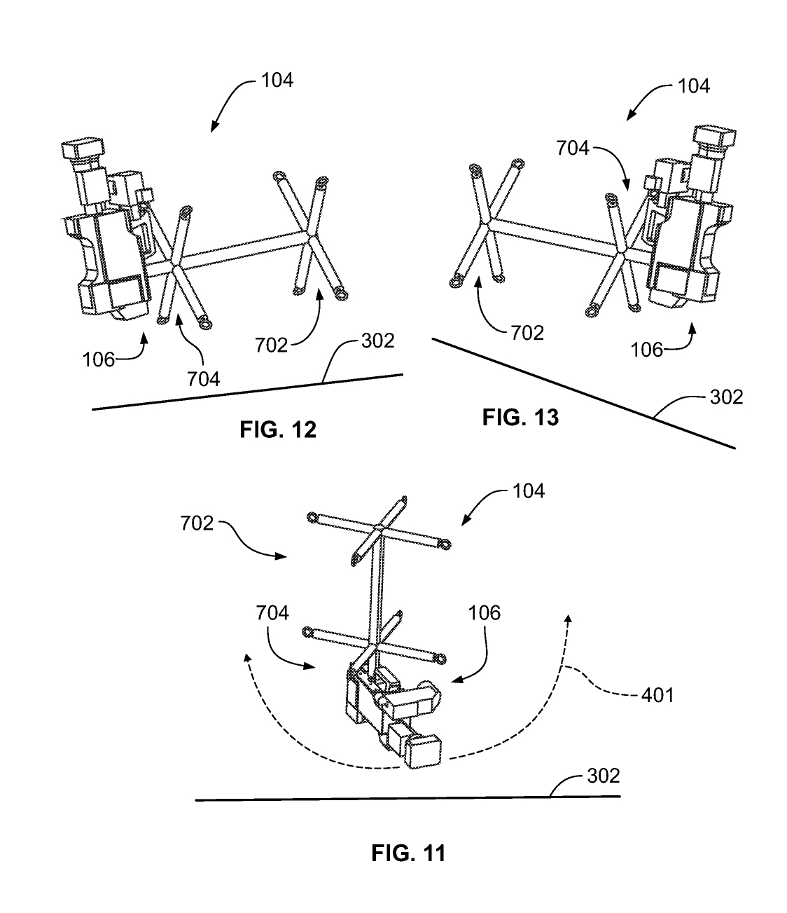

Referring to FIGS. 11-13, the equipment 106 (shown as a camera) is shown having different orientations for movement in response to one or more of the cables 108 being extended and retracted. For example, cables 108 secured to the lower portion 704 and/or the upper portion 702 are selectively and independently retracted and extended to move the equipment. As will be appreciated, any suitable combination of extending and retracting the cables 108 or otherwise adjusting the operation of the reel apparatus 102 without tangling the cables 108 is performed in response to signals provided by the control system 110. In one embodiment, the equipment positioning apparatus 104 includes a weight distribution facilitating a predetermined response. Suitable weight distributions include the weight of the equipment 106 and equipment positioning apparatus 104 being substantially consistent between the upper portion 704 and the lower portion 702, the weight of the equipment 106 and equipment positioning apparatus 104 being greater at the upper portion 704 than the lower portion 702, the weight of the equipment 106 and equipment positioning apparatus 104 being greater at the lower portion 702 than the upper portion, or the weight distribution being adjustable.

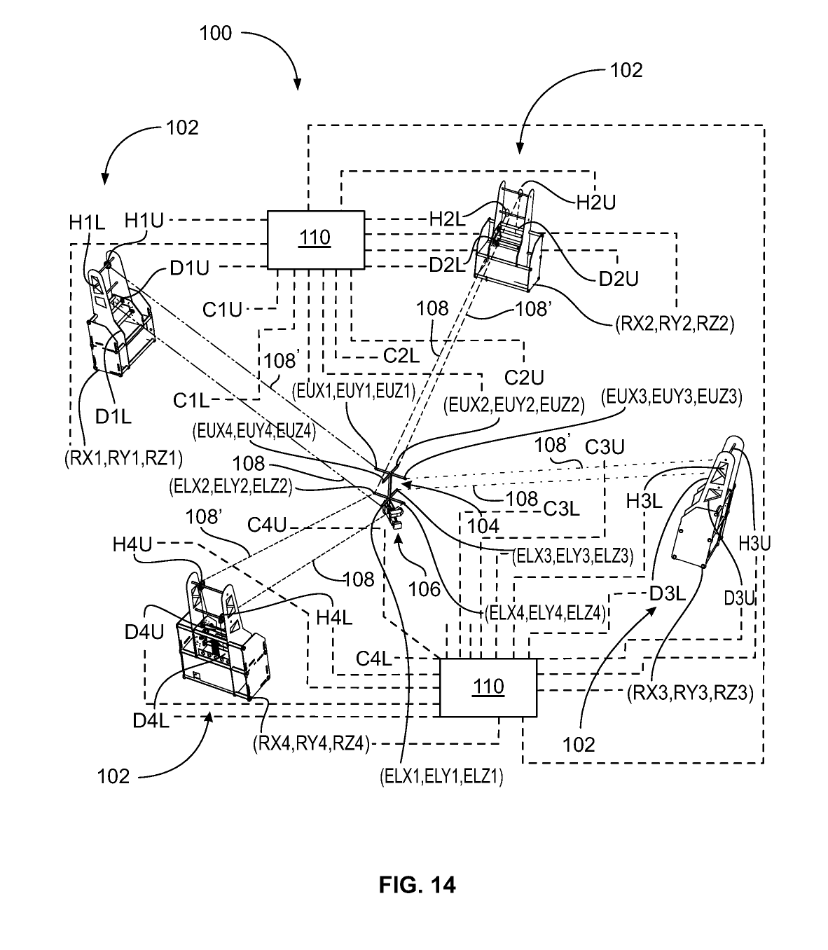

Referring to FIG. 14, in one embodiment, the equipment positioning system 100 includes the control system 110 for selectively positioning the equipment positioning apparatus 104 by extending or retracting the cables 108 in response to data/signal(s). The control system 110 adjusts one or more operational parameters, for example, relating to the selectively adjustable features discussed above.

In one embodiment, the signal is generated in response to data selected from the group consisting of drive power data for the upper cable drive 116 and lower cable drive 114 configured to extend and retract one or more of the cables 108, variable height mechanism position data for the variable height mechanism 602 in the reel apparatus 102 operably connected to one or more of the cables 108, equipment positioning apparatus data for an upper portion 702 and a lower portion 704 of the equipment positioning apparatus 104, and combinations thereof. Other suitable data includes cable length data, reel apparatus position data, equipment weight, other suitable operational parameter data, and combinations thereof.

The data is transmitted to the control system 110 in any suitable manner including, but not limited to, through one or more of the cables 108, wirelessly (for example, through infrared, radio frequency, microwave, or other suitable wireless signals), or combinations thereof The data is gathered by any suitable sensors configured for gathering the various types of data transmitted to the control system 110. The control system 110 adjusts the operational parameters in response to data received. Any numeric, alphabetic, alpha-numeric, symbolic, or otherwise suitable representation is used to represent the data. As shown in FIG. 14, in one embodiment, the data gathered is represented by alpha-numeric identifiers described below.

In one embodiment, the drive power data include values for a first drive and a second drive in the reel apparatus 102 represented by a three-part alpha-numeric identifier. For example, in a further embodiment, a suitable representation of the drive power data includes data values for the reel apparatus 102 including a first drive data value shown as “D1U” identifying the drive power data value for a first drive (for example, the upper cable drive 116) of the first reel apparatus 102 operably connected to the cable engagement feature 112 on the first portion (for example, the top portion 702) of the equipment positioning apparatus 104 and a second drive data value shown as “D1L” identifying the drive power data value for a second drive (for example, the lower cable drive 114) of the first reel apparatus 102 operably connected to the cable engagement feature 112 on the second portion (for example, the lower portion 704) of the equipment positioning apparatus 104. In this embodiment, data values for a second reel apparatus 102 include a first drive data value shown as “D2U” identifying the drive power data value for a first drive (for example, the upper cable drive 116) of the second reel apparatus 102 operably connected to the cable engagement feature 112 on the first portion (for example, the upper portion 702) of the equipment positioning apparatus 104 and a second drive data value shown as “D2L” identifying the drive power data value for a second drive (for example, the lower cable drive 114) of the second reel apparatus 102 operably connected to the cable engagement feature 112 on the second portion (for example, the lower portion 704) of the equipment positioning apparatus 104. In this embodiment, data values for a third reel apparatus 102 include a first drive data value shown as “D3U” identifying the drive power data value for a first drive (for example, the upper cable drive 116) of the third reel apparatus 102 operably connected to the cable engagement feature 112 on the first portion (for example, the upper portion 702) of the equipment positioning apparatus 104 and a second drive data value shown as “D3L” identifying the drive power data value for a second drive (for example, the lower cable drive 114) of the third reel apparatus 102 operably connected to the cable engagement feature 112 on the second portion (for example, the lower portion 704) of the equipment positioning apparatus 104. In this embodiment, data values for a fourth reel apparatus 102 including a first drive data value shown as “D4U” identifying the drive power data value for a first drive (for example, the upper cable drive 116) of the fourth reel apparatus 102 operably connected to the cable engagement feature 112 on the first portion (for example, the upper portion 702) of the equipment positioning apparatus 104 and a second drive data value shown as “D4L” identifying the drive power data value for a second drive (for example, the lower cable drive 114) of the fourth reel apparatus 102 operably connected to the cable engagement feature 112 on the second portion (for example, the upper portion 704) of the equipment positioning apparatus 104. In embodiments with three reel apparatuses 102, data values for the fourth reel apparatus are omitted. In embodiments with more than four reel apparatuses 102, data values for each or some of the additional reel apparatuses are included with a similar representation.

In one embodiment, the equipment positioning apparatus data includes a first data value representing the position of the cable engagement feature 112 on a first portion (for example, the upper portion 702) and a second data value representing the position of the cable engagement feature 112 on a second portion (for example, the lower portion 704) of the equipment positioning apparatus 104. In one embodiment, the first data value and the second data value are represented by a three-part alpha-numeric identifier. For example, in a further embodiment, a suitable representation of the equipment positioning apparatus data includes a first equipment positioning apparatus data value shown as “EUX” identifying the equipment positioning apparatus data position along an X-axis of the first portion (for example, the upper portion 702), a second equipment positioning apparatus data value shown as “EUY” identifying the equipment positioning apparatus data position along a Y-axis of the first portion (for example, the upper portion 702), a third equipment positioning apparatus data value shown as “EUZ” identifying the equipment positioning apparatus data position along a Z-axis of the first portion (for example, the upper portion 702). Additionally, the representation of equipment positioning apparatus data includes a first equipment positioning apparatus data value shown as “ELX” identifying the equipment positioning apparatus data position along an X-axis of a second portion (for example, the lower portion 704), a second equipment positioning apparatus data value shown as “ELY” identifying the equipment positioning apparatus data position along a Y-axis of the second portion (for example, the lower portion 704), a third equipment positioning apparatus data value shown as “ELZ” identifying the equipment positioning apparatus data position along a Z-axis of the second portion (for example, the lower portion 704).

In one embodiment having more than two engagement features 112, equipment positioning apparatus data includes position data for one or more of the additional engagement features 112. For example, in one embodiment having four engagement features 112 on the upper portion 702 and four engagement features 112 on the lower portion 704, the equipment positioning apparatus data includes a first, second, third, and fourth data value representing the position of the first, second, third, and fourth engagement features 112 on the first portion (for example, the upper portion 704) and a first, second, third, and fourth data value representing the position of the first, second, third, and fourth engagement features 112 on the second portion (for example, the lower portion 702). For example, in one embodiment, a suitable representation includes a four-part alpha-numeric identifier for the equipment positioning apparatus data, such as, a first equipment positioning apparatus data value represented by “EUX1” identifying the first engagement feature position along an X-axis of the upper portion 702, “EUY1” identifying the first engagement feature position along a Y-axis of the upper portion 702, and “EUZ1” identifying the first engagement feature position along a Z-axis of the upper portion 702. Likewise, the second engagement feature 112 is represented by “EUX2”, “EUY2”, and “EUZ2”; the third engagement feature 112 is represented by “EUX3”, “EUY3”, and “EUZ3”; and the fourth engagement feature 112 is represented by “EX4”, “EUY4”, and “EUZ4”. In this embodiment, the second equipment positioning apparatus data value is represented by “ELX1” identifying the first engagement feature position along an X-axis of the lower portion 704, “ELY1” identifying the first engagement feature position along a Y-axis of the lower portion 704, and “ELZ1” identifying the first engagement feature position along a Z-axis of the lower portion 704. Likewise, the second engagement feature 112 is represented by “ELX2”, “ELY2”, and “ELZ2”; the third engagement feature 112 is represented by “ELX3”, “ELY3”, and “ELZ3”; and the fourth engagement feature 112 is represented by “ELX4”, “ELY4”, and “ELZ4”.

Likewise, FIG. 14 shows three-part alpha-numeric identifiers for the reel height position data (“H1L”, “HlU”, “H2L”, “H2U”, “H3L”, “H3U”, “H4L”, “H4U”), the cable length data (“C1L”, “C1U”, “C2L”, “C2U”, “C3L”, “C3U”, “C4L”, “C4U”), and reel apparatus position data (“RX1”, “RY1”, “RZ1”, “RX2”, “RY2”, “RZ2”, “RX3”, “RY3”, “RZ3”, “RX4”, “RY4”, “RZ4”). As will be appreciated, the data points shown in FIG. 14, any other suitable data points, or any combination thereof, are mathematically analyzed by a computer program and in conjunction with the control system 110 achieve a selected adjustment to the position of the equipment apparatus 104. The analyzed data is transmitted and received by the control system 110 and the cables 108 are cooperatively extended and retracted in response to a desired position of the equipment positioning apparatus 104.

While only certain features and embodiments of the invention have been shown and described, many modifications and changes may occur to those skilled in the art (for example, variations in sizes, dimensions, structures, shapes and proportions of the various elements, values of parameters (for example, temperatures, pressures, etc.), mounting arrangements, use of materials, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

What is claimed is:

1. An equipment positioning system comprising:
a reel apparatus;
equipment;
a control system;
an equipment positioning apparatus secured to cables forming at least three angled parallelograms extending between the reel apparatus and the equipment positioning apparatus, the cables for positioning the equipment positioning apparatus and the equipment based upon signals from the control system, the cables cooperatively extended or retracted by the reel apparatus thereby positioning one or more of the equipment positioning apparatus and the equipment;
wherein the cables forming the at least three angled parallelograms maintain the equipment positioning apparatus and the equipment in a stable orientation during operation of the equipment positioning system.

2. The system of claim 1, wherein the equipment positioning apparatus includes an upper cable engagement feature and a lower engagement feature.

3. The system of claim 1, wherein the reel apparatus includes a first drive and a second drive.

4. The system of claim 1, wherein the reel apparatus includes a variable height mechanism operably connected to the one or more of the cables.

5. The system of claim 1, wherein the control system includes a controller for selectively positioning the equipment positioning apparatus by extending or retracting the cables, the controller configured to receive data selected from the group consisting of drive power data for a first drive and second drive configured to extend and retract one or more of the cables, variable height mechanism position data for a variable height mechanism in a reel apparatus operably connected to one or more of the cables, equipment positioning apparatus data for a first portion and a second portion of the equipment positioning apparatus, and combinations thereof.

6. An equipment positioning apparatus comprising:
a predetermined number of cable engagement features arranged to be secured to cables to form at least three angled parallelograms extending between a reel apparatus and an equipment positioning apparatus, the cables for positioning the equipment positioning apparatus and the equipment based upon signals from a control system, the cables cooperatively extended or retracted by the reel apparatus thereby positioning one or more of the equipment positioning apparatus and the equipment;
wherein the cables forming the at least three angled parallelograms maintain the equipment positioning apparatus and the equipment in a stable orientation during operation of the equipment positioning apparatus.

7. The apparatus of claim 6, wherein the cable engagement features includes an upper cable engagement feature and a lower engagement feature.

8. The apparatus of claim 6, including a reel apparatus for selectively extending and retracting one or more of the cables thereby positioning equipment operably connected to the one or more cables, the reel apparatus includes a first drive and a second drive.

9. The apparatus of claim 8, wherein the reel apparatus includes a variable height mechanism operably connected to the one or more of the cables.

10. A method for positioning equipment comprising:
providing an equipment positioning apparatus having engagement features; and
selectively positioning the equipment positioning apparatus by selective extension or retraction of cables secured to the equipment positioning apparatus forming at least three angled parallelograms;
wherein the cables forming the at least three angled parallelograms maintain the equipment positioning apparatus and the equipment in a stable orientation during operation of the equipment positioning apparatus.

11. The method of claim 10, wherein the equipment positioning apparatus includes an upper cable engagement feature and a lower engagement feature.

12. The method of claim 10, wherein selectively positioning the equipment positioning apparatus includes selectively positioning an equipment positioning apparatus by selective extension or retraction of at least one of the cables operably connected to a reel apparatus, wherein the reel apparatus includes a first drive and a second drive.

13. The method of claim 12, wherein the reel apparatus includes a variable height mechanism operably connected to at least one of the cables.

14. The method of claim 10, wherein selectively positioning the equipment positioning apparatus includes selectively positioning the equipment positioning apparatus by extending or retracting cables in response to data gathered, the data selected from the group consisting of drive power data for a first drive and second drive configured to extend and retract one or more of the cables, variable height mechanism position data for a variable height mechanism in a reel apparatus operably connected to one or more of the cables, equipment positioning apparatus data for a first portion and a second portion of the equipment positioning apparatus, and combinations thereof.
